(19) United States
(12) Patent Application Publication
(10) Pub. No.: US 2008/0017670 A1
(43) Pub. Date: Jan. 24, 2008

(54) Pump Dispenser

(76) Inventor: Tetsuya Tada, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 11/792,103

(22) PCT Filed: Nov. 29, 2005
(86) PCT No.: PCT/JP05/21873

§ 371 Date: May 31, 2007

(30) Foreign Application Priority Data
Dec. 2, 2004 (JP) 2004-350314

(51) Int. Cl. G01F 11/00

(52) U.S. Cl. 222/321.8

(57) ABSTRACT

It is an object of the present invention to provide a pump dispenser having a ventilation hole at a position higher than a packing seal plane in order to prevent leakage and, at the same time, to cause the pump dispenser to be also advantageous in terms of cost by simplifying the mold structure as much as possible.

The pump dispenser having a cap 1 attached to an opening portion of a container main body 13 containing a liquid has: a housing 2 having a body portion 2a engaged with the cap, a cylinder 3 fit in the housing and disposed above a seal portion, and a piston member 6 slidable in the cylinder; wherein a ventilation hole 3b1 is formed in the cylinder, and a ventilation channel communicated with outside air P for releasing a negative pressure in the container main body is formed between the outer wall of the cylinder and the inner wall of the housing.

The cylinder 3 is fit in the housing so that the cylinder is supported by a rib 2d formed on the inner wall of the housing 2.

### TECHNICAL FIELD

The present invention relates to a pump dispenser for discharging a cleaning liquid, a medicinal liquid, a cosmetic liquid, etc. and particularly relates to a pump dispenser having an improved mechanism for adjusting the pressure in the space of a container main body to which the pump dispenser is attached.

### BACKGROUND ART

Conventionally, there has been known a structure in which a through hole communicated with the outside air is formed in an upper portion of a cylinder for adjusting the pressure in the space of the container main body to which a pump dispenser is attached (for example, see Patent Document 1).

An example of the pump dispenser which has the structure and is actually manufactured by the present applicant will be described below with reference to drawings.

FIG. 9 (A) and FIG. 9 (B) show the inner structure of the pump dispenser.

FIG. 9 (A) is a cross sectional view of the pump dispenser, and FIG. 9 (B) is a cross sectional view taken along the line A-A of FIG. 9 (A).

A cap 101 of the pump dispenser attached to a container main body 100 is engaged with a projection 102a1 formed on a cylinder portion 102a. The cylinder portion 102a is integrally formed with a handle portion 102b and constitutes a housing 102 as a whole.

A ventilation hole 102a2 is formed in the side surface of the cylinder portion 102a slightly below the projection 102a1.

A piston member 103 is slidably inserted in the cylinder portion 102a, and the piston member 103 is capable of switching the state of the interior of the container main body and the outside air between a communicated state and an uncommunicated state via the ventilation hole 102a2.

The piston member 103 is fit in the lower end of a piston shaft 104, and wing portions 104a are formed in a cross shape at the upper end side of the piston shaft 104.

The wing portions 104a slide in the vicinity of the upper end side of the cylinder portion 102a.

The outside air P is in communication with the interior space S1 of the cylinder portion 102a through the space between the wing portions 104a.

In FIG. 9 (A), the piston member 103 is positioned at the top dead center, and the ventilation hole 102a2 and the interior space S1 are in the uncommunicated state.

When a nozzle cap 105a of a nozzle 105 of FIG. 9 (A) is opened and a trigger 106 is pulled, the state shown in FIG. 10 (A) is attained.

FIG. 10 (A) is a cross sectional view of the pump dispenser, and FIG. 10 (B) is a cross sectional view taken along the line B-B of FIG. 10 (A).

As shown in the drawings, when the trigger 106 is pulled, a turning shaft K serves as an axis so that the trigger 106 is lowered, thereby pressing down the piston shaft 104.

When the piston member 103 coupled to the lower end of the piston shaft 104 is pressed down, the liquid F confined in sealed interior space S3 of the cylinder portion 102a is jetted out.

When press-down of the piston member 103 progresses to some extent, the gap between the inner wall of an opening portion of the container main body 100 and the outer wall of the cylinder portion 102a (this gap is communicated with the interior of the container main body, i.e., interior space S2) is communicated with the outside air P via the ventilation hole 102a2.

Therefore, as shown by an arrow in the drawing, the outside air P flows in and the negative pressure is eliminated.

Note that the volume of the air that flows in is approximately equal to the volume of the liquid F jetted out from the nozzle 105 by pulling the trigger 106.

When the state shown in FIG. 11 is attained by obliquely inclining the pump dispenser that is in the state of FIG. 10 (A), as shown in FIG. 12 in which it is enlarged, the liquid F in the container main body 100 flows into the gap between the inner wall of the opening portion of the container main body 100 and the outer wall of the cylinder portion 102a.

When the pump dispenser is transversely inclined in such a state, the liquid F flows to the outside via the ventilation hole 102a2 of the cylinder portion 102a and through the wing portions 104a. In other words, leakage occurs.

Therefore, in order to prevent occurrence of such leakage, the ventilation hole 102a2 is preferred to be at a position that is high as much as possible.

However, the conventional ventilation hole 102a2 cannot be positioned above the cap 101, specifically, higher than the position of the projection 102a1 engaged with the inner wall of the cap 101.

Therefore, a method of further forming a cylindrical portion inside the cylindrical portion on which the projection 102a1 is formed has been invented by the applicant.

Hereinafter, a specific mode thereof will be described with reference to FIG. 13.

As shown in the drawing, a housing 201 is provided inside a cap 200.

A cylinder portion 201a is formed in the housing 201.

A projection 201a1 engaged with a thick portion at an upper end side of the inner wall of the cap 200 is formed in the cylinder portion 201a.

Inside the cylinder portion 201a, a tubular portion 201b having a cylindrical shape is formed, and a ventilation hole 201c is formed at an upper end side of the tubular portion 201b.

When the position of the projection 201a1 is a packing seal plane L, conventionally, it has been difficult to form the ventilation hole higher than the packing seal plane L as described above.

However, as a result of forming the cylindrical portion in a double structure, the projection 201a1 is not required to be formed on the tubular portion 201b; therefore, the restriction imposed on the position for forming the ventilation hole 201c is eliminated, and the ventilation hole can be formed at a higher position.

[Patent Document 1]

Japanese Patent Application Laid-Open (kokai) No. 2002-200443 (FIG. 1, FIG. 3)

### DISCLOSURE OF THE INVENTION

### Problems to be Solved by the Invention

However, when a double cylindrical structure like that illustrated in FIG. 13 is employed, corresponding to the shape thereof, the mold structure also becomes complex, and the cost is high.

When distortion (for example, eccentricity) is generated in the cylinder portion, the whole housing 201 becomes a defective product, which is uneconomical.

Moreover, it is difficult to use a durable material merely for the cylinder portion that undergoes friction.

The present invention has been accomplished based on the background art in order to solve the above described problems of the background art.

More specifically, it is an object of the present invention to provide the ventilation hole at a position higher than the packing seal plane in order to prevent leakage and to provide a pump dispenser which is also advantageous in terms of cost by simplifying the mold structure as much as possible.

### Means for Solving the Problems

Thus, the present inventor has carried out extensive studies for such problem background; and, as a result, the present inventor has found out that the above described problems can be solved by providing a housing having a body portion engaged with a cap, a cylinder fit in the housing and disposed above the cap, and a piston member slidable in the cylinder and employing a double cylindrical structure in which the housing and the cylinder are separate members and accomplished the present invention based on this finding.

More specifically, the present invention resides in (1) a pump dispenser having a cap attached to an opening portion of a container main body containing a liquid, comprising: a housing having a body portion engaged with the cap; a cylinder fit in the housing and disposed above a seal portion; and a piston member slidable in the cylinder; wherein a ventilation hole is formed in the cylinder, and a ventilation channel communicated with outside air for releasing a negative pressure in the container main body is formed between an outer wall of the cylinder and an inner wall of the housing.

The present invention also resides in (2) the pump dispenser described in above (1), wherein a first fold portion and a second fold portion below the first fold portion for sealing the interior of the cylinder are formed in the piston member.

The present invention also resides in (3) the pump dispenser described in above (2), wherein the ventilation hole of the cylinder is positioned above the first fold portion in the state in which the interior of the container main body and the outside air are mutually communicated.

The present invention also resides in (4) the pump dispenser described in above (2), wherein the ventilation hole of the cylinder is positioned between the first fold portion and the second fold portion in the state before the liquid in the container main body is jetted.

The present invention also resides in (5) the pump dispenser described in above (1), wherein a large-diameter portion of the piston member is welded on the housing with pressure so as to block the ventilation channel.

The present invention also resides in (6) the pump dispenser described in above (1), wherein the cylinder is fit in the housing so that the cylinder is supported by a rib formed on the inner wall of the housing.

The present invention also resides in (7) the pump dispenser described in above (1), wherein an annular handle portion is formed in the housing for facilitating holding of the pump dispenser.

Note that, unless deviating from the object of the present invention, a configuration of an arbitrary combination of above described (1) to (7) can be employed.

### EFFECTS OF THE INVENTION

The pump dispenser of the present invention has a housing having a body portion engaged with a cap, a cylinder fit in the housing and disposed above a seal portion, and a piston member slidable in the cylinder, wherein a ventilation hole is formed in the cylinder, and a ventilation channel communicated with the outside air for releasing a negative pressure in the container main body is formed between the outer wall of the cylinder and the inner wall of the housing; therefore, the interior of the container main body and the outside air can be mutually communicated when needed so as to adjust the pressure.

Since the housing and the cylinder are separate members, the degree of freedom in designing is increased, restrictions are eliminated, and the ventilation hole can be positioned above the packing seal plane in order to prevent leakage.

In addition, the structure of molds becomes simpler, which is also advantageous in terms of cost.

### BEST MODES FOR CARRYING OUT OF THE INVENTION

Hereinafter, best modes for carrying out of the present invention will be described with reference to drawings.

FIG. 1 shows an embodiment of a pump dispenser of the present invention.

FIG. 2 (A) and FIG. 2 (B) are exploded views of the pump dispenser of FIG. 1.

The pump dispenser of this embodiment has a cap 1 attached to an opening portion of a container main body containing a liquid.

The cap 1 is formed in a short tube-like shape, and a female screw 1a is formed on the inner wall thereof for screwing itself with the opening portion of the container main body.

In the upper end side of the cap 1, a tapered thick portion 1b is formed in order to engage itself with a housing 2.

On the other hand, ribs 1c are formed on the outer wall of the cap 1 along the longitudinal direction of the cap in order to make it easier to screw the cap 1 with the container main body by fingers or the like.

On the other hand, the housing 2 has a tubular body portion 2a engaged with the cap 1 and an annular handle portion 2b.

Since the pump dispenser can be supported by inserting fingers in the handle portion 2b, jetting can be readily performed even when it is inclined.

At a lower end side of the body portion 2a, an annular projection 2a1 is formed, and it is engaged with the thick portion 1b of the cap 1 from the upper side.

Thus, downward movement is eliminated and it is reliably fixed to the cap 1 by virtue of the annular handle portion 2b.

When the housing 2 is to be attached to the cap 1, the lower end side of the housing 2 is strongly inserted into the cap from the upper side and is slid on the tapered thick portion 1b while the projection 2a1 is bent.

Engagement is completed when an engagement sound is produced when the projection 2a1 is at a position lower than the thick portion 1b.

Consequently, the opening portion of the container main body and the housing 2 are fixed by the projection 2a1, thereby defining a seal plane L (see FIG. 3).

A cylinder 3 comprising a narrow tubular portion 3a and a wide tubular portion 3b is fit in the tubular body portion 2a of the housing 2.

In the upper-end-side side surface of the wide tubular portion 3b, a ventilation hole 3b1 forming part of a ventilation channel, which will be described later, is formed.

When the cylinder 3 is to be engaged with the housing 2, the narrow tubular portion 3a is positioned in the lower side.

The narrow tubular portion 3a has a part in the middle at which the diameter is slightly different, and a ball valve 4 is provided at the part.

The upper end side of a long thin tube 5 for sucking up the liquid in the container main body is attached to the lower end side of the narrow tubular portion 3a.

A piston member 6 is inserted inside the inner wall of the wide tubular portion 3b of the cylinder 3 so as to be slidable.

The piston member 6 has a narrow tubular portion 6a and a skirt portion 6b, which is widen toward the end.

In the skirt portion 6b of the piston member 6, a first fold portion 6b1 for sealing the interior of the cylinder and a second fold portion 6b2 positioned below the first fold portion 6b1 are formed.

The piston member 6 functions to switch the state of the outside air and the interior of the container main body (i.e., interior space S2) between a communicated state and an uncommunicated state via the ventilation hole 3b1 by the first fold portion 6b1 and the second fold portion 6b2 in the manner described below.

A rocket-like valve rod 7 is inserted in the skirt portion 6b of the piston member 6.

A part of the inner wall of the narrow tubular portion 6a serves as a valve seat 6a1, and the distal end portion of the valve rod 7 serves as a valve portion 7a.

A vamplate portion 7b is formed at the lower end side of the valve rod 7, and a spring 8 is provided between the vamplate portion 7b and the step portion of the narrow tubular portion 6a and the skirt portion 6b of the piston member 6.

The lower end side of the piston shaft 9 is externally fit onto the narrow tubular portion 6a of the piston member 6.

The distal end side of the piston shaft 9 has a ball-like spherical surface.

In addition, a liquid jetting portion 9a horizontally extending toward the front is formed in the piston shaft 9.

The distal end side of the liquid jetting portion 9a has a double tubular portion comprising an inner tubular portion 9a1 and an outer tubular portion 9a2, and a channel for jetting the liquid is formed in the inner tubular portion 9a1.

The rear end side of a tubular nozzle 10 is fit in the tubular gap between the inner tubular portion 9a1 and the outer tubular portion 9a2.

A nozzle cap 10a is integrally formed at the distal end side of the nozzle 10.

A spring-equipped valve 11 having a spring portion 11a having a helical shape is provided between the piston shaft 9 and the nozzle 10.

A valve portion 11b which uses the inner wall of the liquid jetting portion 9a as a valve seat is formed at the rear end of the spring-equipped valve 11.

On the other hand, at the distal end of the valve-equipped portion 11, a chip portion 11c which abuts a window portion 10b at the nozzle distal end side and guides the flow of the jetting liquid is formed.

Lifting and lowering of the piston shaft 9 is performed by the trigger 12.

A housing portion 12a to which the spherical distal end of the piston shaft 9 is inserted so as to push it is formed in the trigger 12.

Moreover, when the trigger 12 is pulled, the trigger 12 turns about the turning shaft K which is formed by the housing 2 and the trigger 12, and the position of the housing portion 12a is lowered, thereby pressing down the piston shaft 9.

Meanwhile, FIG. 3 shows a state in which a cylinder 3, which is a separated member, is fit in the housing 2, and this is the biggest characteristic part of the present invention.

A gap, i.e., a ventilation channel for communication of the outside air P from the ventilation hole 3b1 into the container main body is formed between the inner wall of the housing 2 and the outer wall of the cylinder 3 shown in the drawing.

The thickness of the upper end side of the cylinder 3 is increased toward the outside so as to form a large-diameter portion 3b2, thereby forming a terminating position of the upper end side of the ventilation channel.

The large-diameter portion of the piston member is welded with pressure onto the housing 2, thereby blocking the ventilation channel.

The step portion of the cylinder 3 and a projection portion 2c of the housing 2 abut on each other; wherein, projections, ribs, or the like can be provided on the outer wall of the cylinder 3 so as to provide space therebetween in order to prevent, as much as possible, elimination of the gap therebetween which leads to closure of the ventilation channel.

In the above described structure, the housing 2 and the cylinder 3 are separate members; therefore, the ventilation hole 3b1 can be provided at a position higher than that of the packing seal plane L in order to prevent leakage.

Moreover, the structure of the mold for forming the housing 2 can be made simple, which is also advantageous in terms of cost.

FIG. 4 shows the state in which the pump dispenser of FIG. 1 is attached to the container main body.

Note that the liquid is shown by a sandy pattern merely in the area lower than the piston member 6 for the sake of convenience, and it is the same in the drawings hereinafter.

As shown in the drawing, the entire pump dispenser is attached by screwing the cap 1 to the opening portion of the container main body 13 filled with the liquid F.

Herein, in the state before jetting the liquid F in the container main body, the height position of the ventilation hole 3b1 of the cylinder 3 is present between the first fold portion 6b1 and the second fold portion 6b2 of the skirt portion 6b of the piston member 6.

More specifically, the second fold portion 6b2 is formed for preventing the liquid F which is sucked up by the tube 5 and contained in the cylinder 3 from being leaked, and the first fold portion 6b1 is formed for preventing the outside air P from being communicated via the ventilation hole 3b1.

Then, when the nozzle cap 10a is opened and the trigger 12 is pulled in this state, the liquid in the cylinder is jetted from the nozzle 10 (FIG. 4→FIG. 5).

In this case, the piston shaft 9 is pushed downward by the trigger 12, the position of the piston member 6 is lowered while the first fold portion 6b1 slides on the inner wall of the cylinder 3, and, after a while, the first fold portion 6b1 is positioned lower than the position of the ventilation hole 3b1.

The outside air P passes by the piston shaft 9, enters the inside of the cylinder 3, and flows into the ventilation channel (the gap between the inner wall of the body portion 2a of the housing 2 and the outer wall of the cylinder 3) via the ventilation hole 3b1.

Then, the outside air P flows into the container main body 13 through the gap, and the negative pressure in the container main body is released.

When pressing force of the trigger 12 is released in this state in order to recover the state of FIG. 4, the piston member 6 is energized by the spring 8 and moved upward, and the interior space S3 of the cylinder is filled with liquid F in the container main body via the tube 5.

Finally, the first fold portion 6b1 is moved to the position higher than the ventilation hole 3b1 so as to block the flow of the outside air P, and the state returns to the state of FIG. 4.

In this state, the interior of the container main body (i.e., the interior space S2) has a negative pressure.

Note that, as shown in FIG. 6, the liquid level is not higher than the seal plane L at most even when the pump dispenser is inclined in this manner in the state that the trigger 12 is pulled, and the level does not reaches the height of the ventilation hole 3b1 (see enlarged drawing shown in FIG. 7).

Therefore, leakage from the ventilation hole 3b1 does not occur.

The present invention has been described above, however, the present invention is not limited to the above described embodiment, and it goes without saying that various other modifications can be made without deviating from the principles thereof.

For example, FIG. 8 (A) and FIG. 8 (B) show another example of the cylinder.

The cylinder 3 generally undergoes injection molding, and the thinner the thickness, the higher the roundness.

Therefore, the cylinder 3 is preferred to be thin; however, when it is thin, deformation readily occurs when it is fit in the housing 2.

Herein, a plurality of ribs 2d are formed on the inner wall of the housing 2, and the cylinder 3 is supported by the ribs 2d; therefore, deformation does not occur.

Moreover, it is also advantageous in terms of cost since the material thereof is reduced.

### INDUSTRIAL APPLICABILITY

The present invention relates to a pump dispenser for discharging a cleaning liquid, a medicinal liquid, a cosmetic liquid, etc. and particularly relates to a pump dispenser having an improved mechanism for adjusting the pressure in the space of a container main body to which the pump dispenser is attached; however, as long as the principles thereof are used, the invention can be applied to other fluid jetting fields, for example, containers of painting, etc., and the range of the application field thereof is wide.

### BRIEF DESCRIPTION OF THE DRAWINGS

FIG. 1 is an explanatory drawing showing an embodiment of a pump dispenser of the present invention.

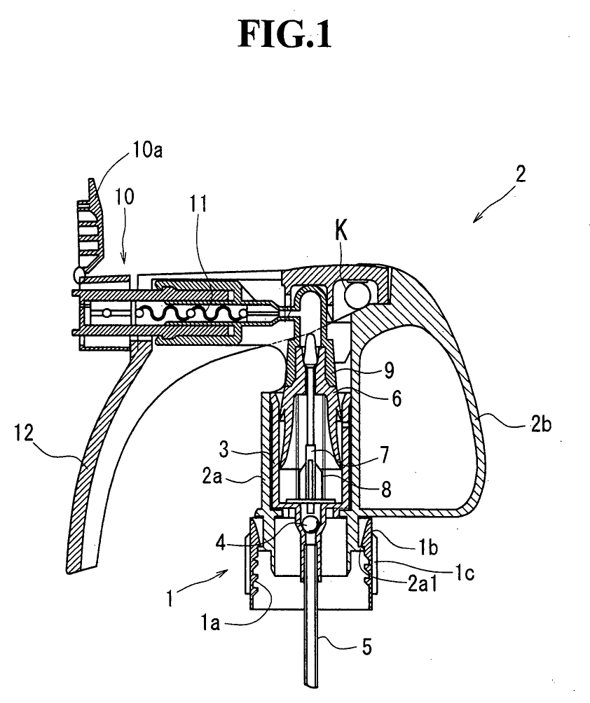

FIG. 2 (A) is an exploded view of the pump dispenser of FIG. 1 and mainly shows parts in the upper side.

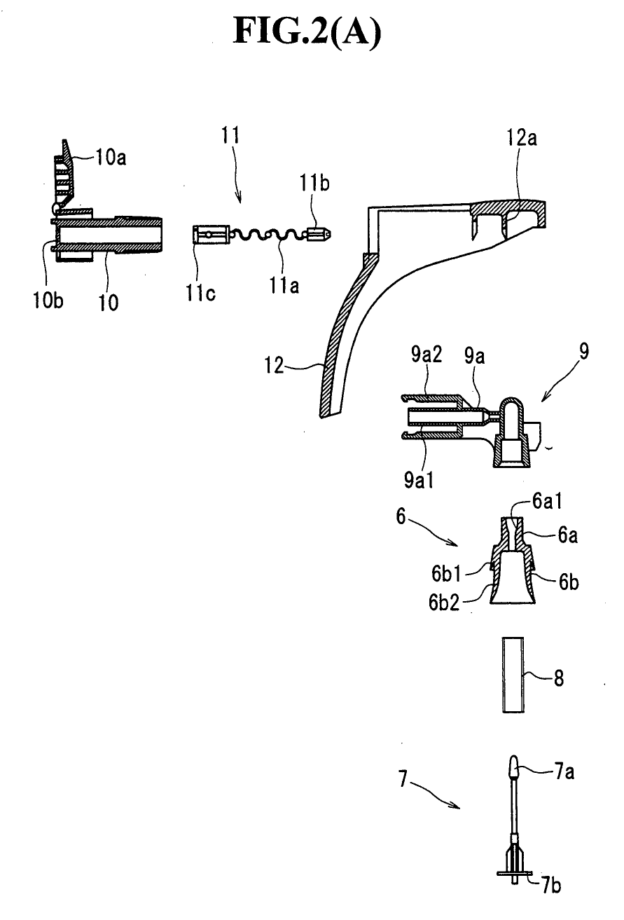

FIG. 2 (B) is an exploded view of the pump dispenser of FIG. 1, and mainly shows parts in the lower side.

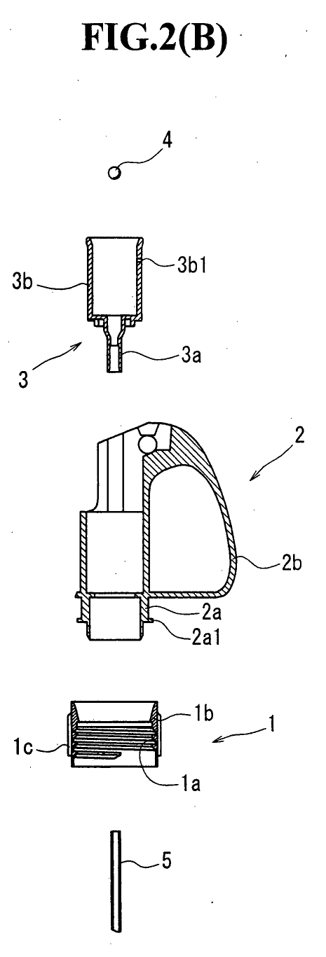

FIG. 3 is an explanatory drawing showing the state in which a cylinder is fit in a housing.

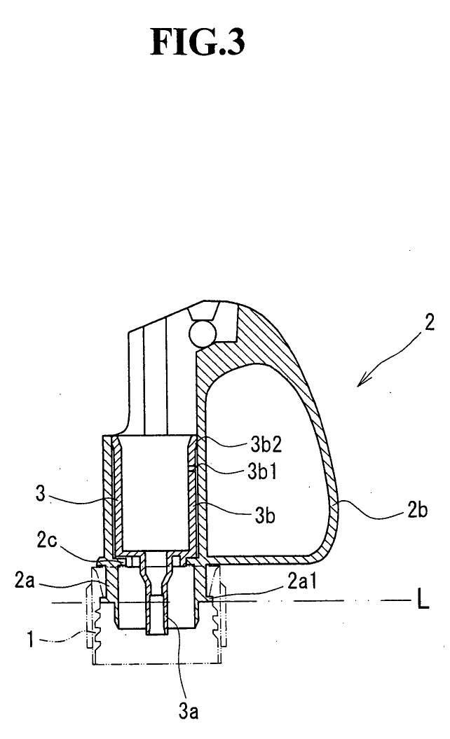

FIG. 4 is an explanatory drawing showing the state of the pump dispenser and a container main body before liquid F in the container main body is jetted.

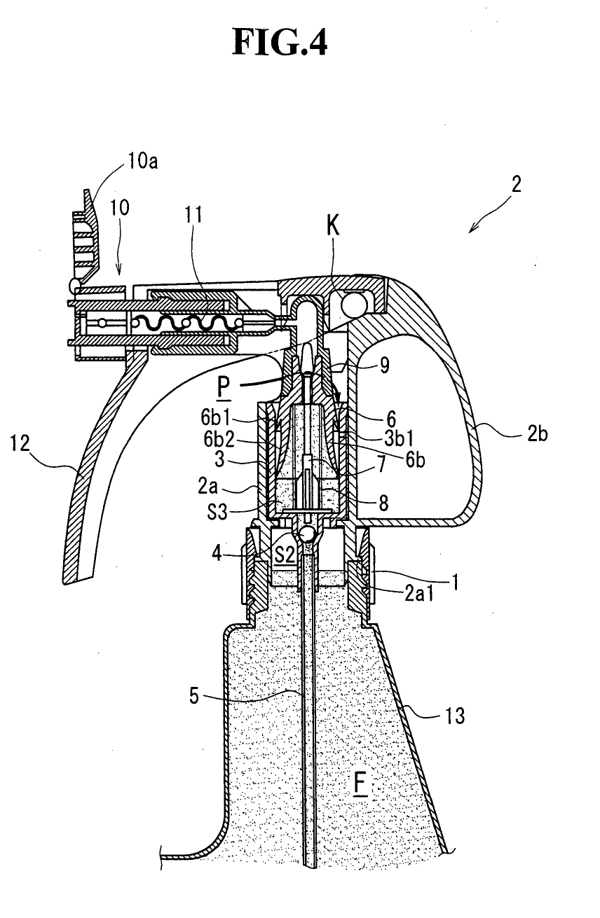

FIG. 5 is an explanatory drawing showing the state in which a trigger of the pump dispenser of FIG. 4 is pulled.

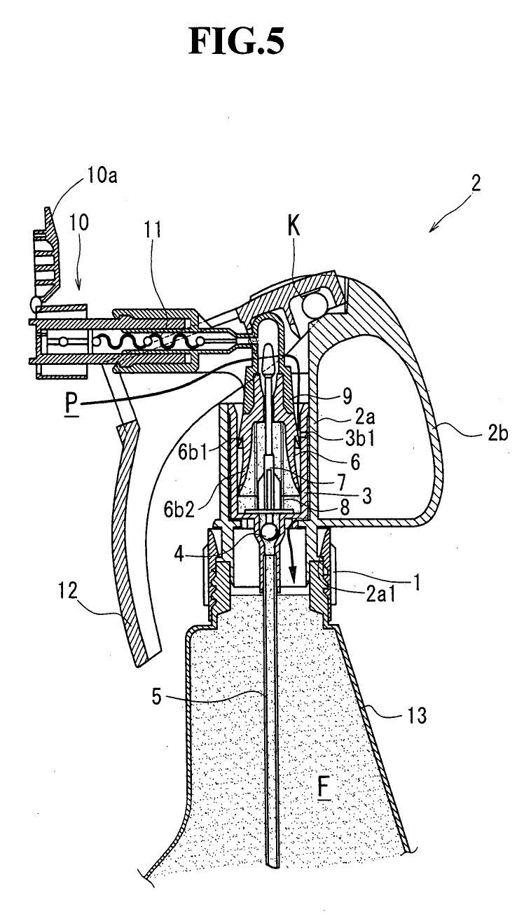

FIG. 6 is an explanatory drawing showing the state in which the pump dispenser is obliquely inclined.

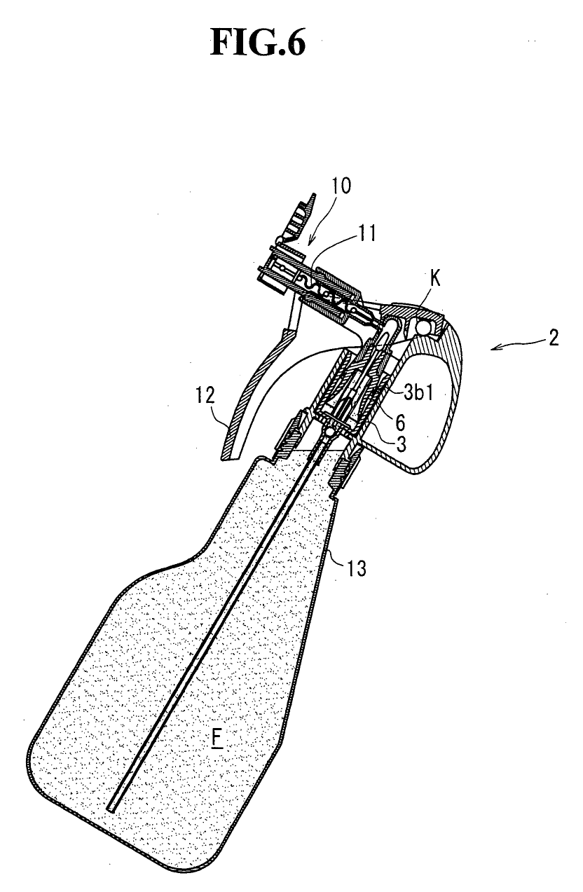

FIG. 7 is an enlarged explanatory drawing showing the state in which the pump dispenser is obliquely inclined.

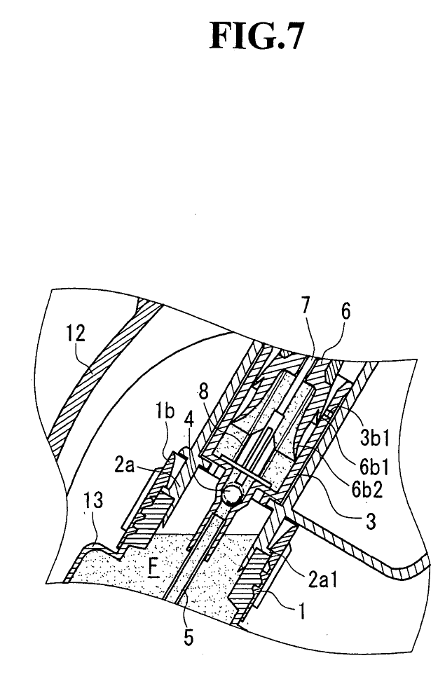

FIG. 8 (A) and FIG. 8 (B) are drawings showing another example of the cylinder.

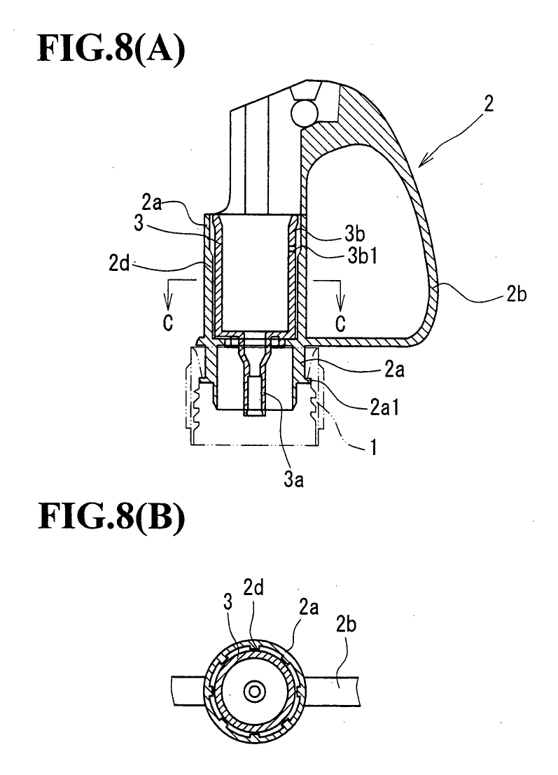

FIG. 9 (A) and FIG. 9 (B) are explanatory drawings showing a first example of a conventional pump dispenser, wherein FIG. 9 (A) shows a cross section, and FIG. 9 (B) shows a cross section taken along the line A-A of FIG. 9 (A).

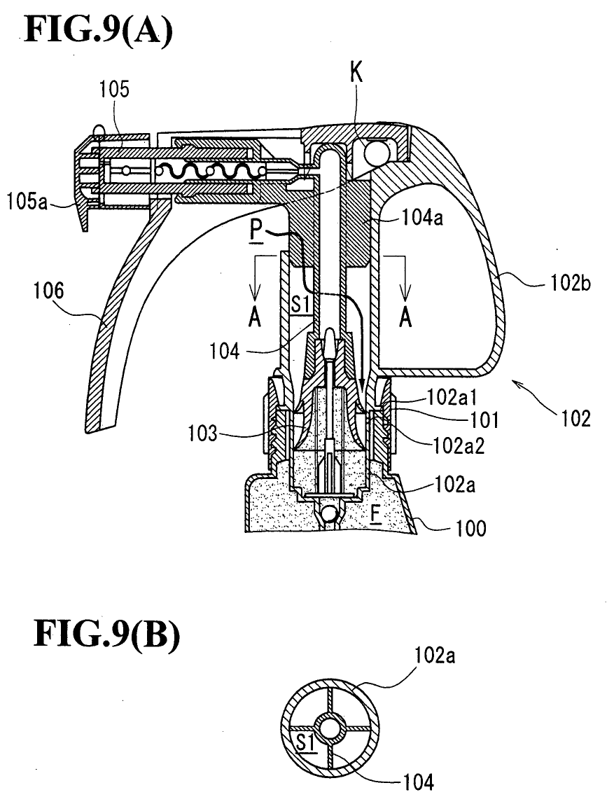

FIG. 10 (A) is an explanatory drawing showing the state in which the trigger of the pump dispenser of FIG. 9 (A) is pulled, FIG. 10 (A) shows a cross section thereof, and FIG. 10 (B) shows a cross section taken along the line B-B of FIG. 10 (A).

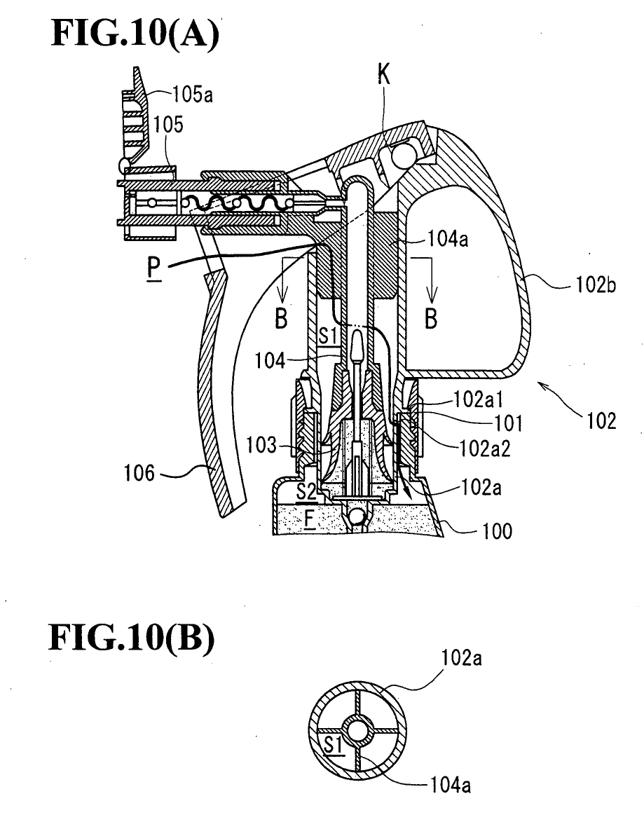

FIG. 11 is an explanatory drawing showing the state in which the pump dispenser is obliquely inclined.

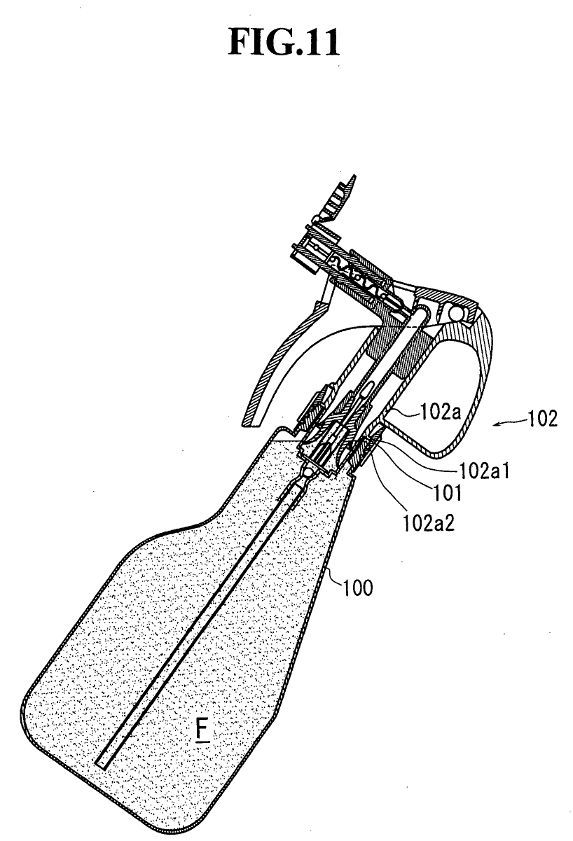

FIG. 12 is an enlarged explanatory drawing showing the state in which the pump dispenser is obliquely inclined.

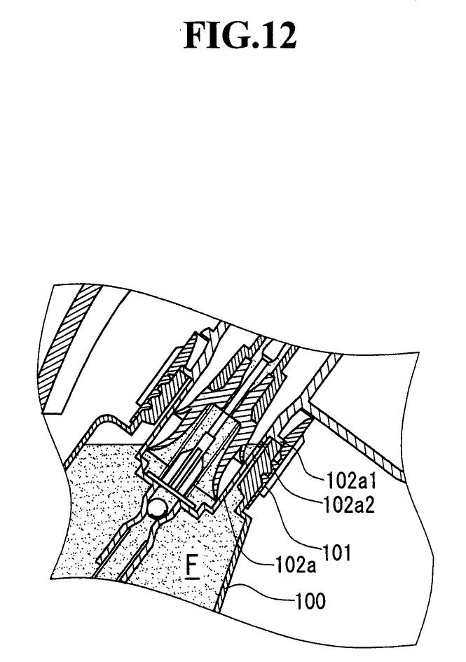

FIG. 13 is an explanatory drawing showing a second example of a conventional pump dispenser.

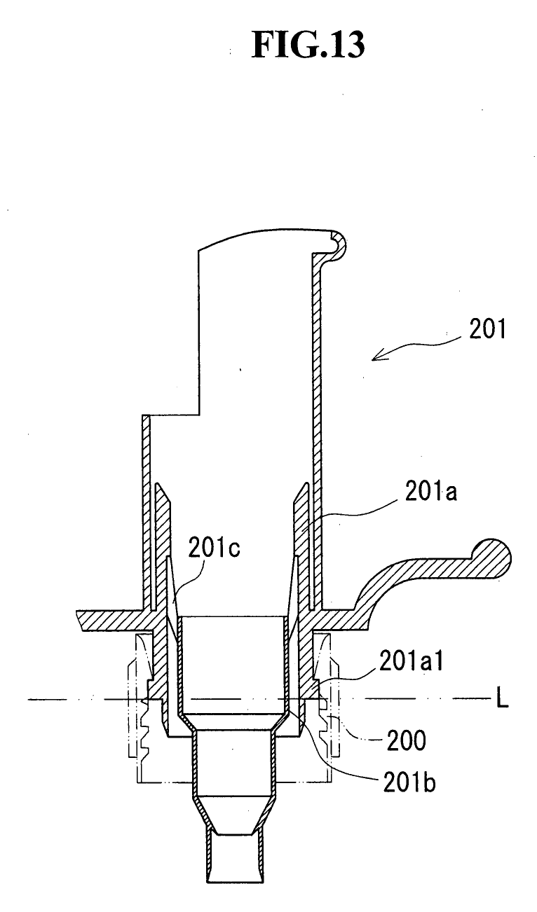

### DESCRIPTION OF REFERENCE NUMERALS

1 CAP
1a FEMALE SCREW
1b THICK PORTION
1c RIB
2 HOUSING
2a BODY PORTION
2a1 PROJECTION
2b HANDLE PORTION
2c PROJECTION PORTION
2d RIB
3 CYLINDER
3a NARROW TUBULAR PORTION
3b1 VENTILATION HOLE
3b2 LARGE-DIAMETER PORTION
4 BALL VALVE
5 TUBE
6 PISTON MEMBER
6a NARROW TUBULAR PORTION
6a1 VALVE SEAT
6b SKIRT PORTION
6b1 First Fold Portion
6b2 SECOND FOLD PORTION
7 VALVE ROD
7a VALVE PORTION
7b VAMPLATE PORTION
8 SPRING
9 PISTON SHAFT
9a LIQUID JETTING PORTION
9a1 INNER TUBULAR PORTION
9a2 OUTER TUBULAR PORTION
10 NOZZLE
10a NOZZLE CAP
10b WINDOW PORTION
11 SPRING-EQUIPPED VALVE
11a SPRING PORTION
11b VALVE PORTION
11c CHIP PORTION
12 TRIGGER
12a HOUSING PORTION
13 CONTAINER MAIN BODY
100 CONTAINER MAIN BODY
101 CAP
102 HOUSING
102a CYLINDER PORTION
102a1 PROJECTION
102a2 VENTILATION HOLE
102b HANDLE PORTION
103 PISTON MEMBER
104 PISTON SHAFT
104a WING PORTION
105 NOZZLE
105a NOZZLE CAP
106 TRIGGER
200 CAP
201 HOUSING
201a CYLINDER PORTION
201a1 PROJECTION
201b TUBULAR PORTION
102c VENTILATION HOLE
F LIQUID
K TURNING SHAFT
L PACKING SEAL PLANE
P OUTSIDE AIR
S1, S2, S3 INTERIOR SPACE

1. A pump dispenser having a cap attached to an opening portion of a container main body containing a liquid, the pump dispenser comprising:
a housing having a body portion engaged with the cap;
a cylinder fit in the housing and disposed above a seal portion; and
a piston member slidable in the cylinder; wherein
a ventilation hole is formed in the cylinder, and a ventilation channel communicated with outside air for releasing a negative pressure in the container main body is formed between an outer wall of the cylinder and an inner wall of the housing.

2. The pump dispenser described in claim 1, wherein a first fold portion and a second fold portion below the first fold portion for sealing the interior of the cylinder are formed in the piston member.

3. The pump dispenser described in claim 2, wherein the ventilation hole of the cylinder is positioned above the first fold portion in the state in which the interior of the container main body and the outside air are mutually communicated.

4. The pump dispenser described in claim 2, wherein the ventilation hole of the cylinder is positioned between the first fold portion and the second fold portion in the state before the liquid in the container main body is jetted.

5. The pump dispenser described in claim 1, wherein a large-diameter portion of the piston member is welded on the housing with pressure so as to block the ventilation channel.

6. The pump dispenser described in claim 1, wherein the cylinder is fit in the housing so that the cylinder is supported by a rib formed on the inner wall of the housing.

7. The pump dispenser described in claim 1, wherein an annular handle portion is formed in the housing for facilitating holding of the pump dispenser.
